(19) United States
(12) Patent Application Publication
(10) Pub. No.: US 2014/0238048 A1
(43) Pub. Date: Aug. 28, 2014

(54) CRYOGENIC SENSOR READOUT MODULE

(71) Applicants: Joseph D. Orndorff, Halethorpe, MD (US); Stephen Hope, Bel Air, MD (US)

(72) Inventors: Joseph D. Orndorff, Halethorpe, MD (US); Stephen Hope, Bel Air, MD (US)

(21) Appl. No.: 13/774,807

(22) Filed: Feb. 22, 2013

(51) Int. Cl. F17C 13/02

(52) U.S. Cl. CPC F17C 13/02
USPC 62/49.1

(57) ABSTRACT

A cryogenic system including a source of cryogen fluid, a cryogenic chamber receiving the cryogen fluid to cool the cryogenic chamber, an exhaust for venting spent cryogen from the cryogenic chamber, a cryogenic sensor positioned in the cryogenic chamber to monitor a condition, and a cryogenic sensor readout module associated with the cryogenic sensor. The cryogenic sensor readout module including a power bus, an excitation bus, a low-noise signal processor, an analog to digital converter, a converter, an output module, a liquid crystal display (LCD), and an Ethernet port.

### BACKGROUND

The present invention is directed to systems and methods for operation of and data collection related to cryogenic systems. The field of cryogenics involves operating temperatures below negative one-hundred-eighty degrees centigrade (−180 degrees Celsius). These low temperatures present unique and, often, difficult operational environments and typically require specialized equipment and instrumentation. For example, sensors and instrumentation used in cryogenic data collection systems have design parameters that are uniquely suited to the cryogenic operational environments and the careful controls necessary to maintain the cryogenic operational environments. These systems are highly sophisticated and precisely controlled to safely and consistently maintain the cryogenic operational environment.

Currently-available sensors and instrumentation for cryogenic systems are typically designed to operate autonomously or, in some cases, in concert with sensors and instrumentation associated with an individual cryogenic system. When a particular instillation site includes multiple cryogenic systems, this requires operator to provide individualized attention to each of the multiple cryogenic systems.

It would be desirable to have a system and method for accurately monitoring and controlling many types of cryogenic sensors and instrumentation, for example, across multiple cryogenic systems in a cost effective manner.

### BRIEF SUMMARY OF THE INVENTION

The present invention overcomes the aforementioned drawbacks by providing a readout module that can interpret the signals from a variety of cryogenic sensors and relay that data to users in an easy and convenient manner.

In one construction, the invention provides a cryogenic system that includes a source of cryogen fluid, a cryogenic chamber receiving the cryogen fluid to cool the cryogenic chamber, an exhaust for venting spent cryogen from the cryogenic chamber, a cryogenic sensor positioned in the cryogenic chamber to monitor a condition, and a cryogenic sensor readout module associated with the cryogenic sensor. The cryogenic sensor readout module including a power bus receiving external power, an excitation bus receiving power from the power bus and outputting excitation current to the cryogenic sensor, a low-noise signal processor for receiving a sensor output and outputting a conditioned output, an analog to digital converter for receiving the conditioned output and outputting a data output, a converter for converting the data output to an engineering output in a desired unit, an output module outputting the engineering output, a liquid crystal display (LCD) receiving the engineering output from the output module and displaying the received engineering output, and an Ethernet port receiving the engineering output and providing the engineering output to a network.

### BRIEF DESCRIPTION OF DRAWINGS

The invention will be better understood and features, aspects and advantages other than those set forth above will become apparent when consideration is given to the following detailed description thereof. Such detailed description makes reference to the following drawings.

FIG. 1 is a schematic representation of a cryogenic signal conditioning unit according to the invention.

FIG. 2 is a perspective view of one construction of the cryogenic signal conditioning unit of FIG. 1.

FIG. 3 is a schematic representation of the cryogenic signal conditioning unit of FIG. 2 with a hall sensor connected.

FIG. 4 is a schematic representation of the cryogenic signal conditioning unit of FIG. 2 with a temperature diode connected.

FIG. 5 is a schematic representation of a cryogenic sensor readout module according to the invention.

FIG. 6 is a schematic representation of a portion of one construction of the cryogenic sensor readout module of FIG. 5.

FIG. 7 is a schematic representation of another portion of one construction of the cryogenic sensor readout module of FIG. 5.

FIG. 8 is a schematic representation of another portion of one construction of the cryogenic sensor readout module of FIG. 5.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

The present invention will be described in terms of one or more preferred embodiments, and it should be appreciated that many equivalents, alternatives, variations, and modifications, aside from those expressly stated, are possible and within the scope of the invention.

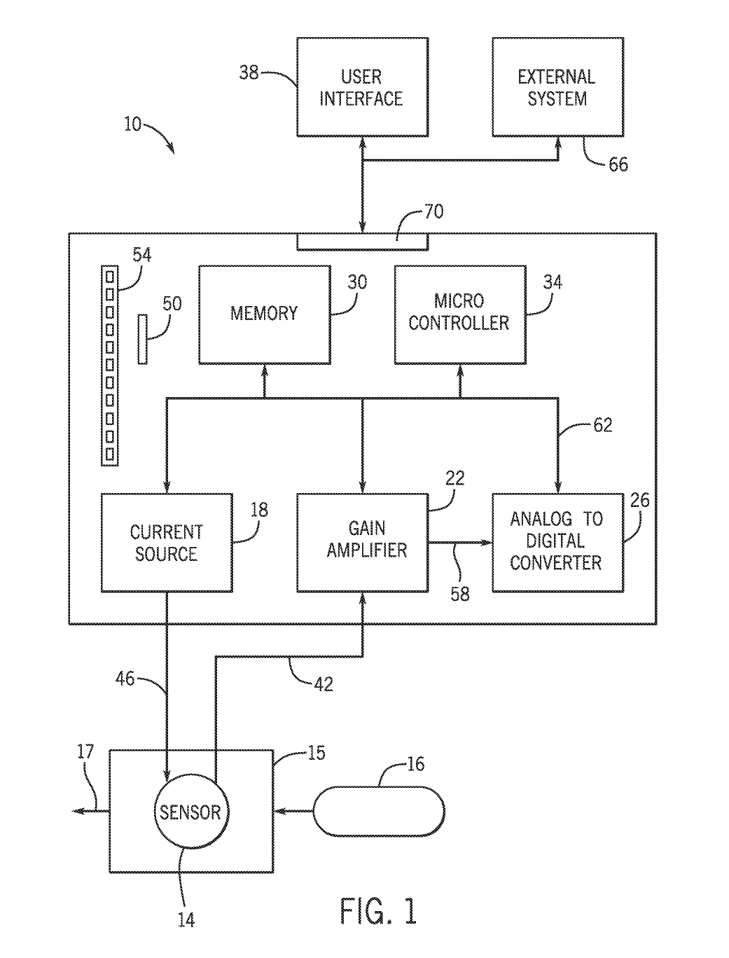

FIG. 1 shows a schematic representation of a cryogenic signal conditioning unit 10 for use with a cryogenic sensor 14. The cryogenic sensor 14 monitors a condition within a cryogenic chamber 15. The cryogenic chamber 15 is supplied with a cryogen (e.g., helium or nitrogen) from a cryogen source 16 and includes an exhaust 17. The flow of the cryogen through the chamber 15 drops the temperature within the chamber 15 to cryogenic temperatures. The cryogenic signal conditioning unit 10 includes a software programmable current source 18, a programmable gain amplifier 22, an analog-to-digital converter (A/D converter 26), a memory 30, a microcontroller 34, and a user interface 38.

Many different types of sensors 14 are used in cryogenic conditions. For example, the sensor 14 may be any one of a temperature diode, a thermistor, a thermocouple, an RTD sensor, a hall sensor, and a pressure transducer. The inventive cryogenic signal conditioning unit 10 could be used with other sensor types as desired. The sensors 14 may output a raw sensor output 42 from between about sub-micro volt to volt levels.

The current source 18 provides the sensor 14 with an excitation current 46 and a value of the excitation current 46 is set according to the specifications of the sensor 14. Typically, the value of the excitation current 46 is between zero milliamps and two-hundred milliamps (0-200 mA). In one construction, the current source 18 has four manually configurable current ranges: 0-200 mA, 0-20 mA, 0-2 mA, and 0-200 uA. To manually set the range of the excitation current 46, a user manually moves a jumper 50 to the appropriate position on a set of jumper pins 54. Alternatively, the excitation current 46 range can be set via software interface as will be discussed below.

The amplifier 22 receives a raw sensor output 42 from the sensor 14 and converts the sensor output 42 to an amplified output 58. This amplification increases the sensor output 42 voltage to a more usable amplified output 58 voltage. Various amplification schedules or tables may be used for determining the appropriate gain amplification, as is understood in the art.

The A/D converter 26 receives the amplified output 58 from the gain amplifier 22 and converts the analog voltage to a data output 62 that is a digital signal that can be used by the cryogenic signal conditioning unit 10. Various circuits and computations can be used for the conversion, as is known in the art.

The memory 30 records the data output 62 and makes the stored data output 62 available for data collection or monitoring. In one example, the memory 30 is an EEPROM type of permanent memory. Other memory types may be used, as desired. The memory 30 also stores settings, configurations, ranges, and other data used by elements of the cryogenic signal conditioning unit 10.

The microcontroller 34 is in communication with the other components of the cryogenic signal conditioning unit 10 and coordinates there actions. For example, the microcontroller 34 recognizes what type of sensor 14 is connected to the cryogenic signal conditioning unit 10 (e.g., by user input), looks up the corresponding excitation current 46 in a look up table of the memory 30, and communicates with the current source 18 to provide the desired excitation current 46 to the sensor 14. Likewise, the microcontroller 34 communicates with the gain amplifier 22 and the A/D converter 26 to maintain the desired operation of the cryogenic signal conditioning unit 10.

The user interface 38 communicates with the cryogenic signal conditioning unit 10 and allows the user to communicate with and control the operation of the unit. For example, the user interface 38 could be a personal computer, a human machine interface (HMI), a network, or another interface that allows communication. The user can directly control the operation of the cryogenic signal conditioning unit 10 by setting the sensor type, excitation current 46, amplification values, and accessing the memory 30.

Additionally, the cryogenic signal conditioning unit 10 is arranged to communicate with an external system 66 such as a computer network or the internet, a cryogenic sensor readout module as discussed below, a data collection system, an LCD readout screen, or another device or system, as desired. A communications port 70 or output bus provides connection of the user interface 38 and the external system 66 to the cryogenic signal conditioning unit 10. Control can be implemented directly to the conditioning unit 10 via the user interface 38 or it can come from remote control via a program or network control. Similarly, control and monitoring can be segregated. For example, many users may be interested in monitoring the condition measured by the sensor 14, but should not be allowed to adjust the operating parameters of the cryogenic signal conditioning unit. Limited access can be controlled to allow select users write or control access while other users are given only read access. Similarly, the units may be setup to allow control from only one source at a time.

The cryogenic signal conditioning unit 10 may be configured to communicate with an industry standard protocol. In one construction, the unit communicates with MODBUS. In other constructions, the unit communicates with Ethernet, CAN, or another commonly used protocol. Additionally, one construction of the unit utilizes RS485 connections for sending the communication. Alternative connection types may be used, as desired to provide easy and cost effective communication.

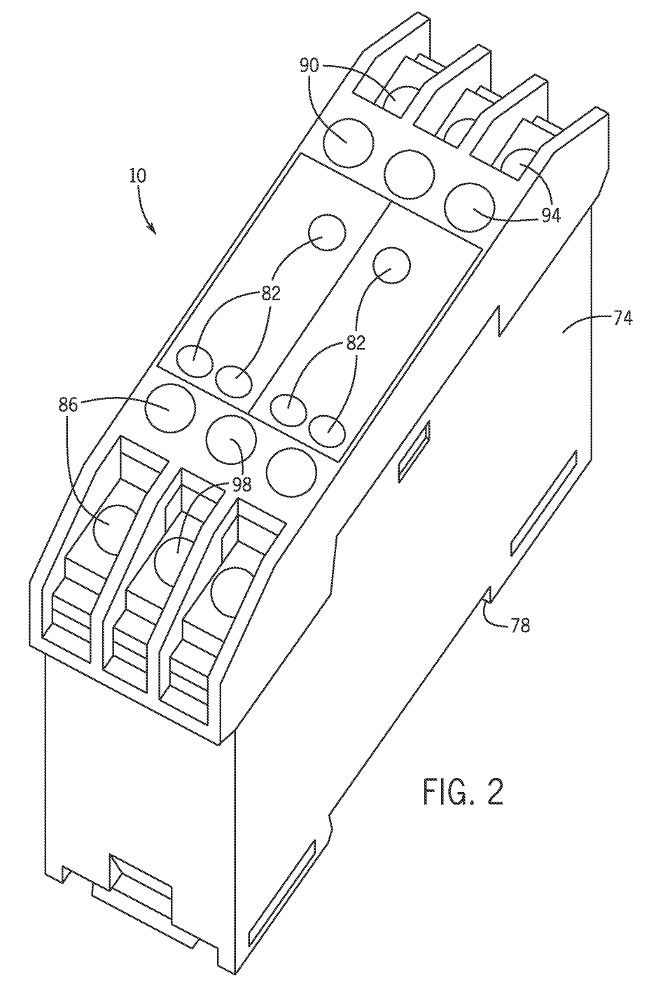

FIGS. 2-4 show one construction of a cryogenic signal conditioning unit 10 according to the invention. The cryogenic signal conditioning unit 10 includes a housing 74 that defines a connecting feature in the form of a DIN rail slot 78, a number of indicator LEDS 82, a power bus 86 for receiving power, an excitation bus 90 for delivering the excitation current 46 to the sensor 14, a sensor bus 94 for receiving the sensor output 42 from the sensor 14, and an output bus 98 for sending the data output 62. Additionally, the cryogenic signal conditioning unit 10 may include different alarm and monitoring busses. The illustrated housing 74 contains the software programmable current source 18, the A/D converter 26, the programmable gain amplifier 22, the memory 30, and the microcontroller 34.

The housing 74 is arranged such that the unit is small and fits easily into a control panel. The DIN rail slot 78 allows for mounting of a number of cryogenic signal conditioning units 10 in a compact space. This compact arrangement is substantially refined when compared to the bulky, complicated, and difficult to implement systems currently available.

The indicator LEDS 82 can be used for diagnostic purposes to understand how the cryogenic signal conditioning unit 10 is operating at any given time. For example, a fault may show a red LED 82, normal operation may light a green LED 82, a power LED may illuminate next to the word power, or other indicators may be used, as desired.

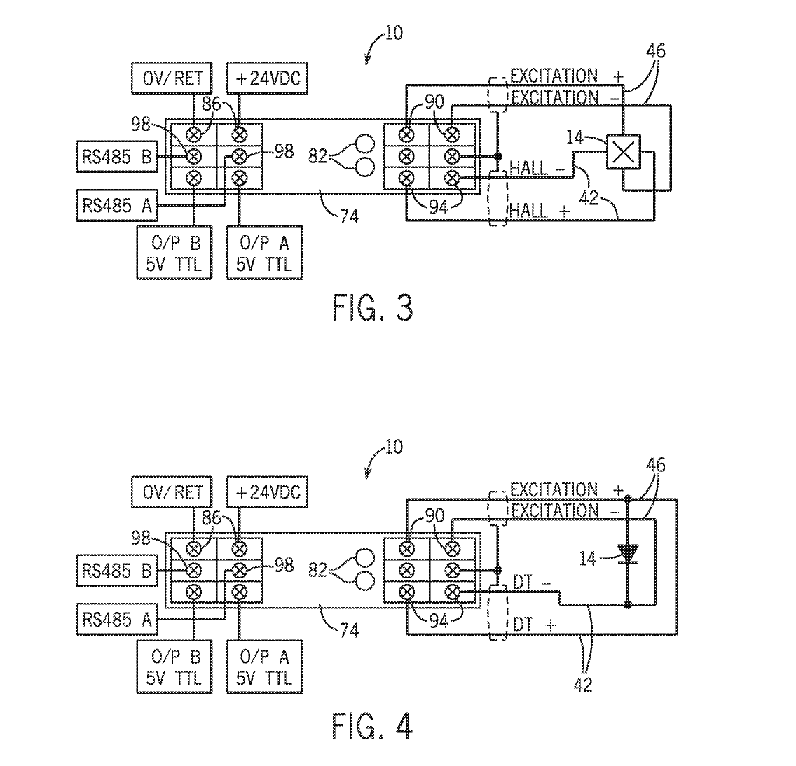

FIG. 3 shows a typical connection for a hall effect sensor 14 and FIG. 4 shows a typical connection for a temperature diode. The power bus 86 is illustrated receiving 24 VDC, the output bus 98 is connected to a RS485 device, the excitation bus 90 is connected to the respective sensor 14, and the sensor bus 94 is connected to the sensor output 42.

In operation, the cryogenic signal conditioning unit 10 may be installed into a service panel and connections are made to the sensor 14, the communications bus 98, and power bus 86. The housing 74 is opened and the user moves the jumper 50 to an appropriate position for the sensor 14 such that the excitation current 46 range is correct. Then, the user closes the housing 74, and accesses the unit 10 via the user interface 38 and sets the sensor 14 type. The excitation current 46 and amplification values are then set automatically. Alternatively, the user can manually set the excitation current 46 and amplification values. The sensor 14 can then be operated and the data output 62 collected. The data output 62 represents the readings of the sensor 14.

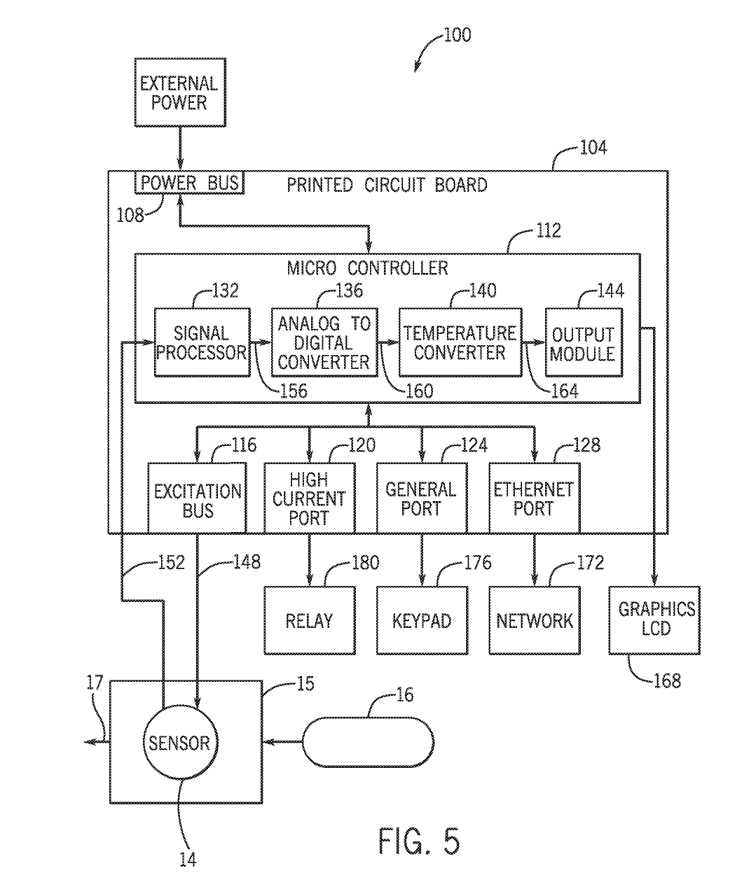

FIG. 5 shows a schematic representation of a cryogenic sensor readout module 100 according to the invention for use with the sensor 14. The cryogenic sensor 14 monitors a condition within a cryogenic chamber 15. The cryogenic chamber 15 is supplied with a cryogen (e.g., helium or nitrogen) from a cryogen source 16 and includes an exhaust 17. The flow of the cryogen through the chamber 15 drops the temperature within the chamber 15 to cryogenic temperatures. The readout module 100 may be used in conjunction with the cryogenic signal conditioning unit 10 or independent thereof. The following discussion will detail how the readout module 100 may be used independent of the cryogenic signal conditioning unit 10 first, and be followed by a discussion of how the cryogenic signal conditioning unit 10 may be used together with the readout module 100.

The readout module 100 includes a printed circuit board 104 that includes a power bus 108 for receiving power, a microcontroller 112, an excitation bus 116, a high current port 120, a general port 124, and a communications port in the form of an Ethernet port 128.

The microcontroller 112 includes a low-noise signal processor 132, an analog-to-digital converter (A/D converter 136), a converter 140, and an output module 144. The microcontroller 112 also controls the communication of the readout module 100, the operation and coordination of the various components, includes a memory, controls signals sent to and from the sensor 14, and other aspects as will be apparent to those skilled in the art.

The microcontroller 112 provides an excitation current 148 to the excitation bus 116 which is then passed onto the sensor 14. The excitation current 148 is set according to the specifications of the type of sensor 14 used. As with the cryogenic signal conditioning unit 10, the excitation current 148 can be from between about zero milliamps and about two-hundred milliamps (0-200 mA). Other excitation currents may be used, as desired. The excitation current 148 is provided to the excitation bus 116, where the excitation current 148 is provided to the sensor 14.

The sensor delivers a low voltage sensor output 152. This low voltage is provided to the low-noise signal processor 132 where the sensor output 152 may be amplified, conditioned, filtered, or undergo other conditioning. After the sensor output 152 is processed, the low-noise signal processor 132 outputs a conditioned output 156 to the A/D converter 136 where the conditioned output 156 is converted into a usable digital signal in the form of a data output 160. The data output 160 is provided to the converter 140 where the data output 160 is calculated into an engineering output 164 according to the sensor 14 type. For example, a temperature diode's sensor output 152 will be conditioned and converted into an engineering output 164 that reads as a temperature value in degrees Kelvin. The engineering output 164 is then provided to the output module 144 where it may be disseminated to a graphics LCD 168, the Ethernet port 128, the general port 124, or another component of the readout module 100.

In one example of the readout module 100, the output module 144 provides the engineering output 164 to the graphics LCD 168 and shows the user what the sensor 14 is reading. Additionally, the engineering output 164 is provided to a network 172 via the Ethernet port 128 where the user may access the data via a computer connected to the network 172. A Java™ interface, or other network based program, allows the user to interact with the collected data and use the data. For example, the program could provide the user with a chart showing the engineering output 164 over time. A network 172 based interface provides a controlled and easy to use access mode for the collected engineering output 164. Further, the readout module 100 can be controlled from the network 172. Access for read, write, administrative, et cetera rights may be provided to various users depending on their individual access rights. For example, a user with administrative rights may be able to program the readout module 100 for the sensor 14 type, engineering output 164 units, conversion equations, or other control aspects.

Additionally, a keyboard 176 or other user interface may be directly connected to the readout module 100. This would allow a user to configure the readout module 100 manually by communicating through the keyboard 176 and the graphics LCD 168. Further, the high current port 120 can be used to control an external device such as a relay 180, alarm, or other device. This allows the readout module 100 to control a system dependant on the sensor output 152.

The cryogenic signal conditioning unit 10 may also be used with the readout module 100. For example, the cryogenic signal conditioning unit 10 may communicate a data output 160 to the readout module 100 through the network 172, or directly. That data output 160 could then be converted to an engineering output 164 and used by the readout module 100.

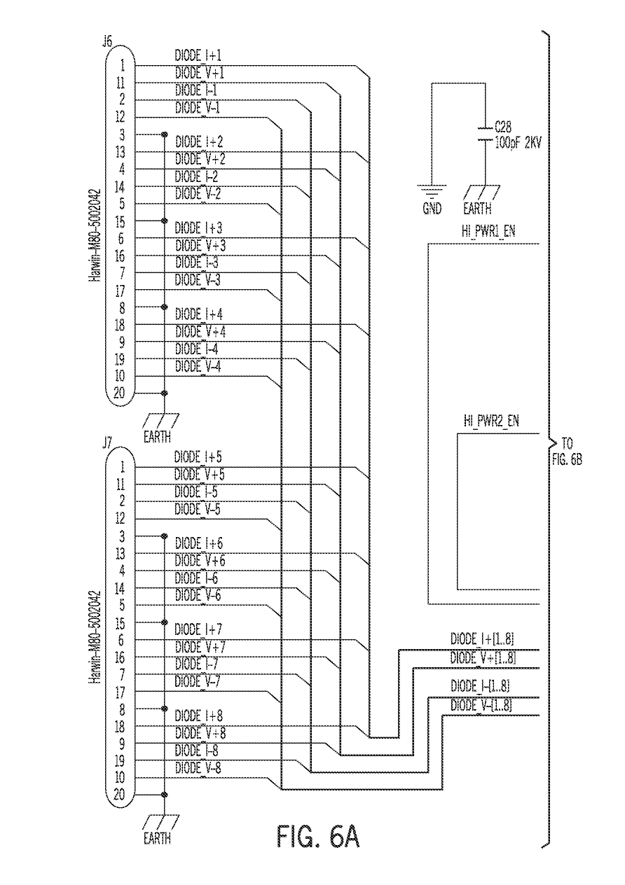

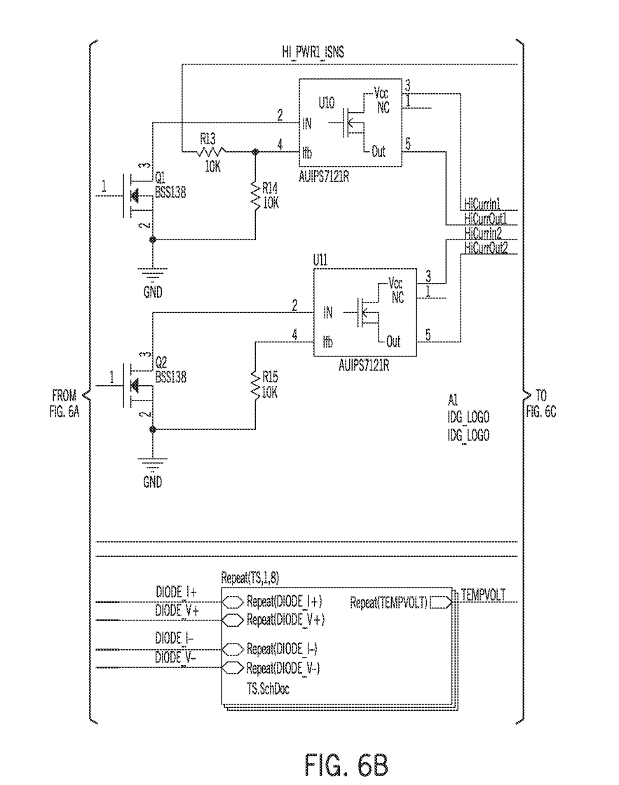

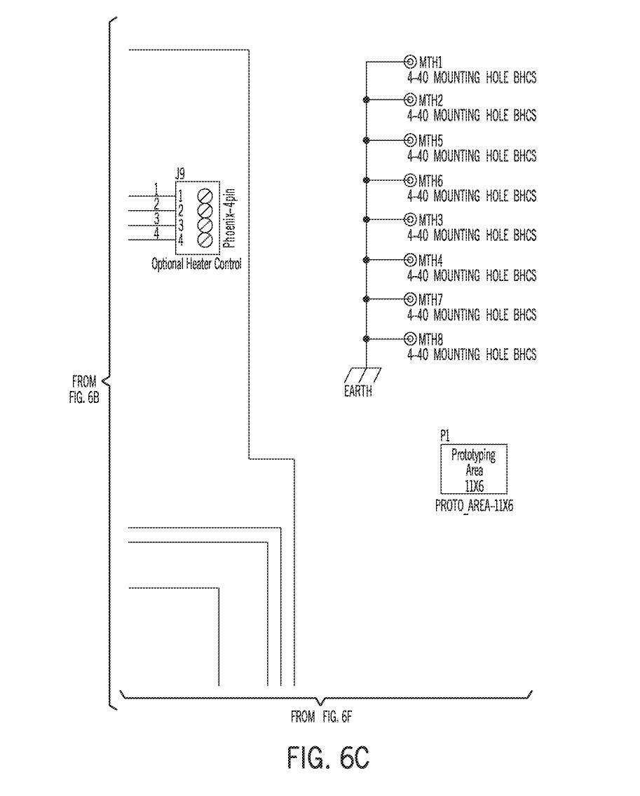

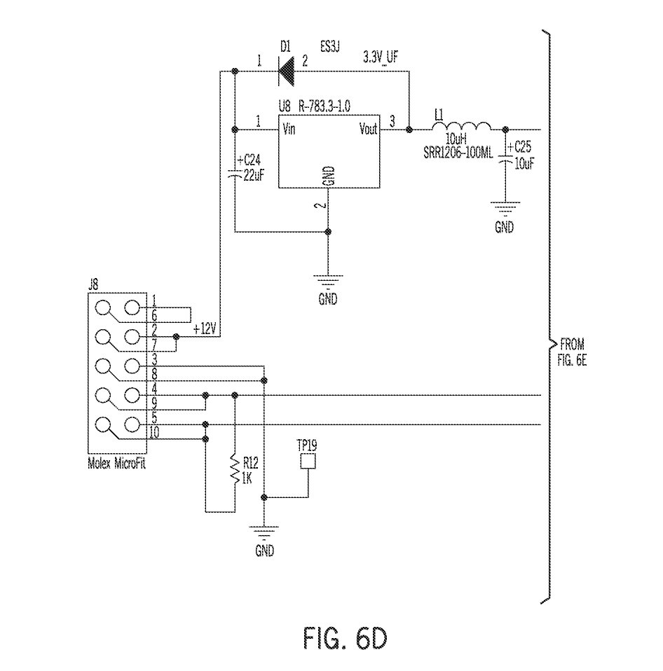

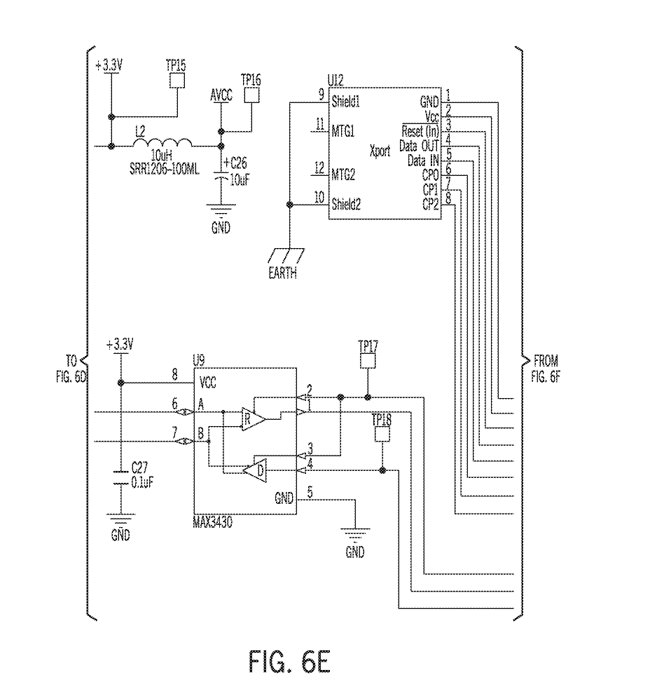

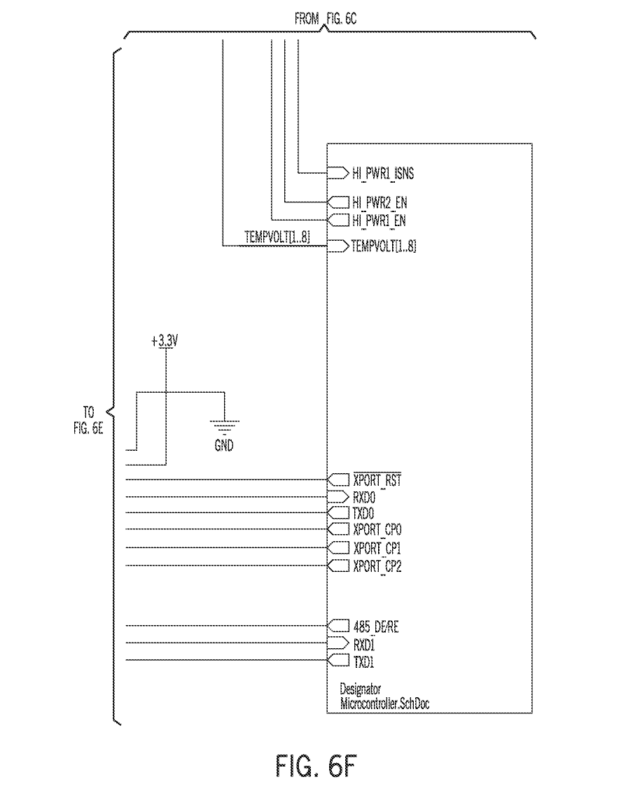

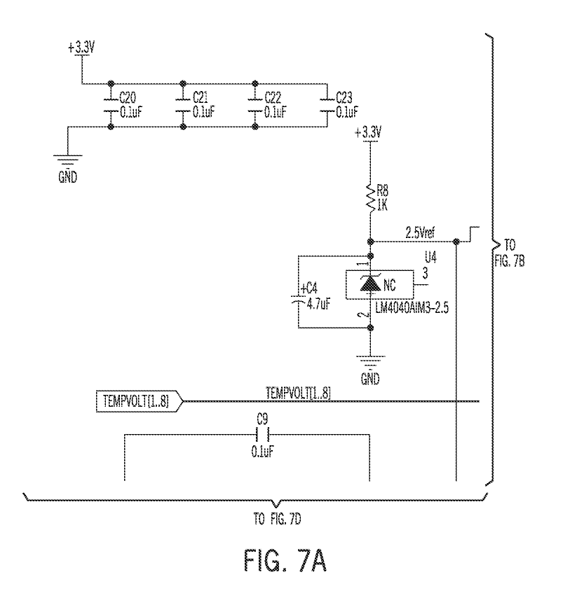

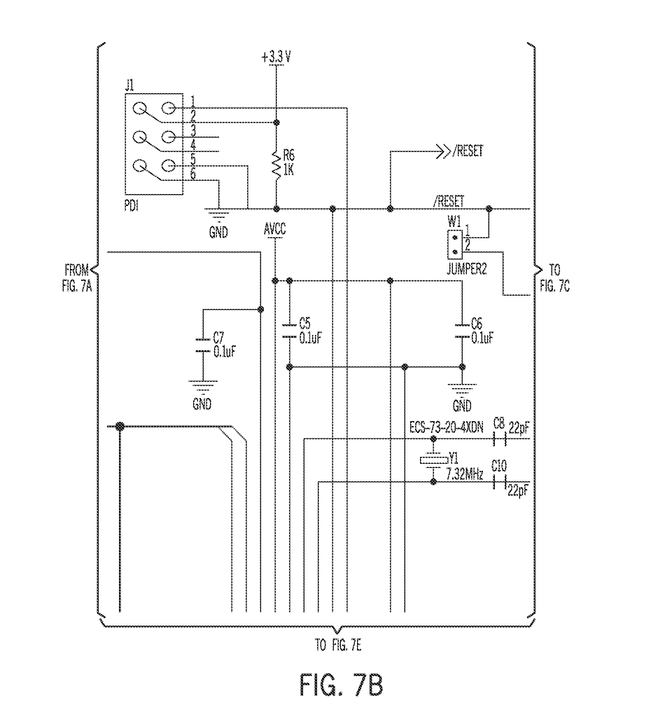

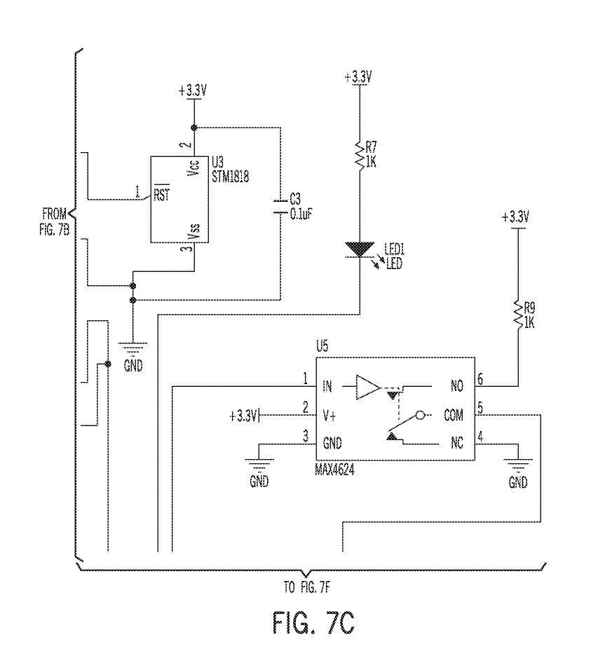

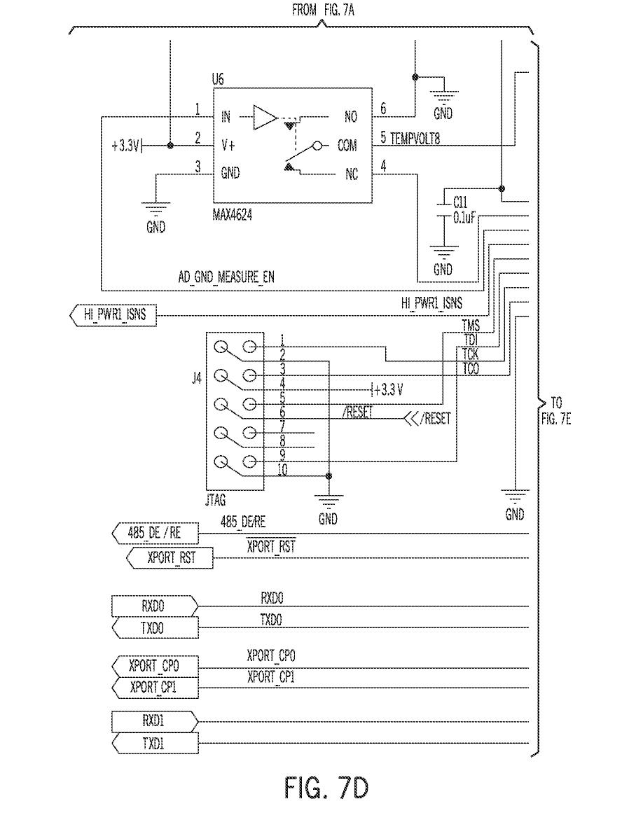

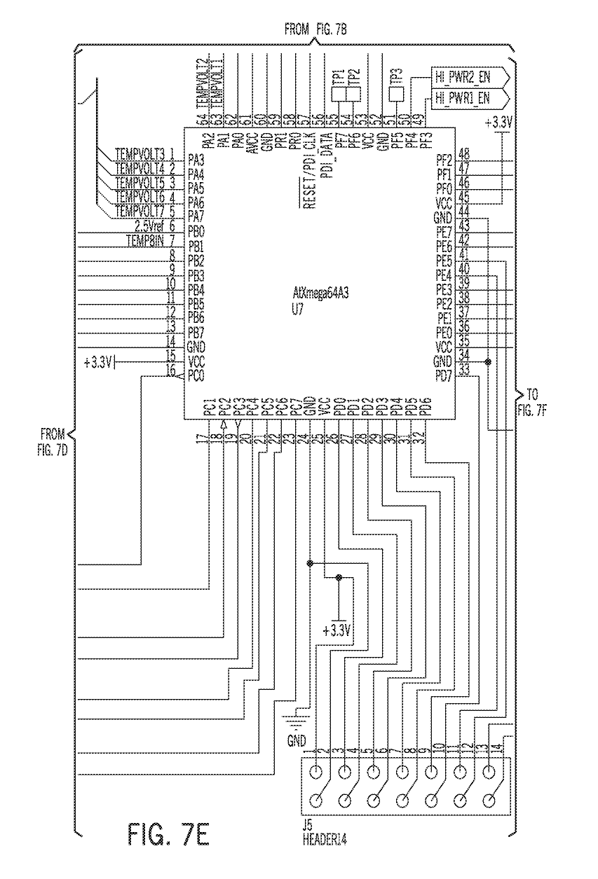

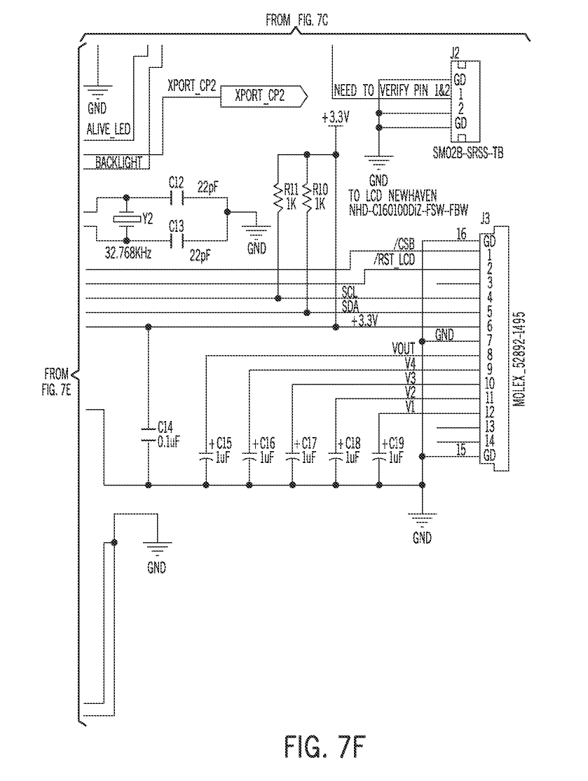

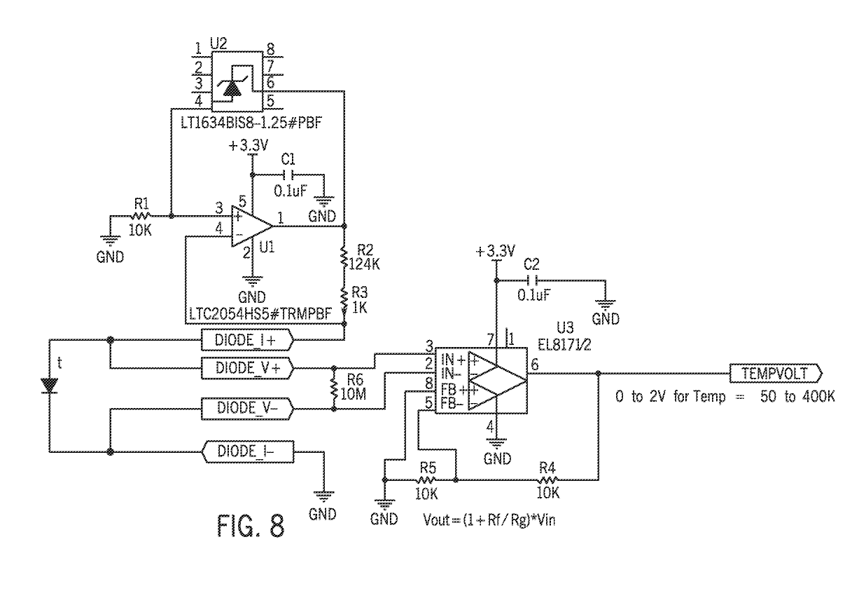

FIGS. 6-8 show one construction of a readout module 100 according to the invention. In the illustrated construction, the readout module 100 can utilize eight sensors 14 and output eight sets of engineering outputs 164. As shown, the various components of the readout module 100 may be realized on a single chip, multiple chips, multiple circuits, a single circuit, or a single printed circuit board 104.

The readout module 100 is intended to provide a small sized component that can be easily integrated into cryogenic systems. The only readout modules currently available are highly complex and difficult to use. This system would make the readout and use of data from cryogenic sensors 14 much more accessible. The readout module 100 meets a long felt need in the area of cryogenics.

We claim:

1. A cryogenic system comprising:
a source of cryogen fluid;
a cryogenic chamber receiving the cryogen fluid to cool the cryogenic chamber;
an exhaust for venting spent cryogen from the cryogenic chamber;
a cryogenic sensor positioned in the cryogenic chamber to monitor a condition; and
a cryogenic sensor readout module associated with the cryogenic sensor, the cryogenic sensor readout module including
a power bus receiving external power,
an excitation bus receiving power from the power bus and outputting excitation current to the cryogenic sensor,
a low-noise signal processor for receiving a sensor output and outputting a conditioned output,
an analog to digital converter for receiving the conditioned output and outputting a data output,
a converter for converting the data output to an engineering output in a desired unit;
an output module outputting the engineering output,
a liquid crystal display (LCD) receiving the engineering output from the output module and displaying the received engineering output, and
an Ethernet port receiving the engineering output and providing the engineering output to a network.

2. The cryogenic system of claim 1, wherein the power bus the excitation bus, the low-noise signal processor, the analog to digital converter, the converter, the output module, and the Ethernet port are mounted on a printed circuit board.

3. The cryogenic system of claim 1, wherein the low-noise signal processor can process sensor output from eight cryogenic sensors.

4. The cryogenic system of claim 1, wherein the analog to digital converter has eight inputs.

5. The cryogenic system of claim 1, wherein the LCD is configured to display at least eight sets of engineering outputs.

6. The cryogenic system of claim 1, wherein the engineering output is relayed via the Ethernet port to the network in universal data packets.

7. The cryogenic system of claim 1, further comprising a general purpose port connected to a keypad.

8. The cryogenic system of claim 1, further comprising a high current controlled channel that may be used to operate a relay or other device.

9. The cryogenic system of claim 1, wherein the low-noise signal processor, the analog to digital converter, the converter, and the output module are part of a microcontroller.

10. The cryogenic system of claim 9, wherein the functions of the low-noise signal processor, the analog to digital converter, the converter, and the output module may be altered via software and firmware.

11. The cryogenic system of claim 9, wherein the microcontroller can alter the operation of the low-noise signal processor, the analog to digital converter, the converter, and the output module depending on the type of cryogenic sensor.

12. The cryogenic system of claim 11, wherein the cryogenic sensor is one of a temperature diode, a thermistor, a thermocouple, an RTD sensor, a hall sensor, and a pressure transducer, the microcontroller altering the operation of the low-noise signal processor, the analog to digital converter, the converter, and the output module depending on the sensor type.

13. The cryogenic system of claim 1, wherein the network is in communication with the cryogenic sensor readout module, and
wherein the network includes a user interface that a user may interact with to alter the operation of the cryogenic sensor readout module.

14. The cryogenic system of claim 13, wherein the user interface is a network based software and the user interacts with the software on a computer.

15. The cryogenic system of claim 1, wherein the network includes a data collection system.

16. The cryogenic system of claim 1, further comprising a housing.

17. The cryogenic system of claim 1, wherein the Ethernet port communicates via RS-485 protocol.
